(19) United States
(12) Patent Application Publication
(10) Pub. No.: US 2019/0026637 A1
(43) Pub. Date: Jan. 24, 2019

(54) METHOD AND VIRTUAL DATA AGENT SYSTEM FOR PROVIDING DATA INSIGHTS WITH ARTIFICIAL INTELLIGENCE

(71) Applicant: Sunil MEHTA, Haryana (IN)

(72) Inventor: Sunil MEHTA, Haryana (IN)

(21) Appl. No.: 16/068,891

(22) PCT Filed: Jan. 9, 2017
(86) PCT No.: PCT/IN2017/050012

§ 371 Date: Jul. 9, 2018

(30) Foreign Application Priority Data
Jan. 8, 2016 (IN) 201611000820

(51) Int. Cl. G06N 5/04; G06N 99/00

(52) U.S. Cl. CPC G06N 5/043; G06N 99/005

(57) ABSTRACT

The present invention relates to a method and system for providing data insights with artificial intelligence. The method and system of the present invention comprises the steps and a component for processing the incoming data from one or more sources, the incoming data can be of any type, and any volume and can come at any velocity, the steps and a component for converting the data into a squeezed matrix, the steps and a component for finding insights from this data matrix using artificial intelligence, the artificial intelligence could use approaches of rule based expert systems, evolutionary computing, neural networks, Bayesian Network, and the like, and the steps and a component for scoring these insights based on usefulness to human beings. One or more visualizations including the data insights are displayed to an end user.

### FIELD OF THE INVENTION

The present invention generally relates to data analysis and more particularly to a method and virtual data agent system for providing data insights with artificial intelligence.

### BACKGROUND TO THE INVENTION

Typically, human beings as business analysts, data scientists and the like, are tasked to find the insights from the data so that decisions could be made to grow the businesses, where business can even be humanity. The data scientists and business analysts use intelligence, previous learnings, experience and domain expertise to identify the correlations, joins, filtering, and the like that should be applied on the data to determine the data insights.

The natural limitations of human beings like incapability to continuously use their brains for analysis while maintaining high efficiency throughout, to abstract emotional biases from logical analysis, to think of all the potential possibilities and more, reduce the value derived out of data and hence the quality and speed of decisions made on the basis of data.

U.S. Pat. No. 7,711,670 discloses an agent engine includes a definition process, the definition process operable to define a data set associated with an objective, a library storing a set of components, the components comprising at least one of a pre-programmed application, object, algorithm, function, and data set definition, and an agent generator process, the agent generator process operable to define at least one agent that includes at least one component from the library, the at least one generated agent defined to perform a function related to the objective.

### SUMMARY OF THE INVENTION

This summary is provided to introduce a selection of concepts in a simplified format that are further described in the detailed description of the invention. This summary is not intended to identify key or essential inventive concepts of the subject matter, nor is it intended for determining the scope of the invention.

An example of a computer-implemented method of providing data insights with artificial intelligence includes linking data, by a virtual data agent system, from one or more data sources. The data can be one of any format, type, and volume. The method also includes processing of the data with artificial intelligence. The method further includes aggregating data and converting the data into a data matrix using artificial intelligence. The method includes generating the data insights and predictions with artificial intelligence. The data insights can further be scored with artificial intelligence. Moreover, the method includes displaying one or more visualizations including the data insights to an end user.

In an embodiment, a system for a virtual data agent to provide insights with artificial intelligence including a processor, a memory communicatively coupled to the processor, configured for: linking data from one or more data sources by a data fetching component, aggregating and convert the linked data into a data matrix by a data aggregator component, generating a plurality of data insights from the data matrix by a data depth creation component, generating a score for the plurality of data insights by a scoring component, and displaying a plurality of visualizations, by a visualization component, based on the score of the data insights, processing big data using a sampling component, and improving intelligence by an AI learning database component.

To further clarify advantages and features of the present invention, a more particular description of the invention will be rendered by reference to specific embodiments thereof, which is illustrated in the appended figures. It is appreciated that these figures depict only typical embodiments of the invention and are therefore not to be considered limiting of its scope. The invention will be described and explained with additional specificity and detail with the accompanying figures.

### BRIEF DESCRIPTION OF THE FIGURES

The invention will be described and explained with additional specificity and detail with the accompanying figures in which:

FIG. 1A is an example representation of an environment, in accordance with an embodiment;

FIG. 1B is an example representation of a virtual data agent system, in accordance with an embodiment;

FIG. 2 is a screenshot illustrating a display screen of a virtual data scientist system during data linkage, in accordance with an embodiment;

FIG. 3 is a graphical representation illustrating variation of level distribution with respect to input data, in accordance with an embodiment;

FIG. 4 is a graphical representation illustrating variation of survived count with respect to average fare, in accordance with an embodiment;

FIG. 5 is a graphical representation illustrating variation of passenger class count with respect to average fare, in accordance with an embodiment;

FIG. 6 is a graphical representation illustrating variation of passenger class count with respect to average age, in accordance with an embodiment;

FIG. 7 is a graphical representation illustrating variation of survived count with respect to sex percentage of passengers, in accordance with an embodiment;

FIG. 8 is a graphical representation illustrating variation of survived count with respect to passenger class percentage, in accordance with an embodiment;

FIG. 9 is a graphical representation illustrating variation of number of people with respect to survival rate per title, in accordance with an embodiment;

FIG. 10 illustrates an example flow diagram of a method for providing data insights based on artificial intelligence, in accordance with an embodiment;

FIG. 11 illustrates a block diagram of an electronic device, in accordance with one embodiment; and

FIG. 12 illustrates a flow diagram of a method of generating insights by a virtual data engine system, in accordance with an embodiment.

Further, skilled artisans will appreciate that elements in the figures are illustrated for simplicity and may not have been necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having benefit of the description herein.

### DESCRIPTION OF THE INVENTION

For the purpose of promoting an understanding of the principles of the invention, reference will now be made to the embodiment illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Appearances of the phrase “in an embodiment”, “in another embodiment” and similar language throughout this specification may, but do not necessarily, all refer to the same embodiment

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present invention will be described below in detail with reference to the accompanying figures.

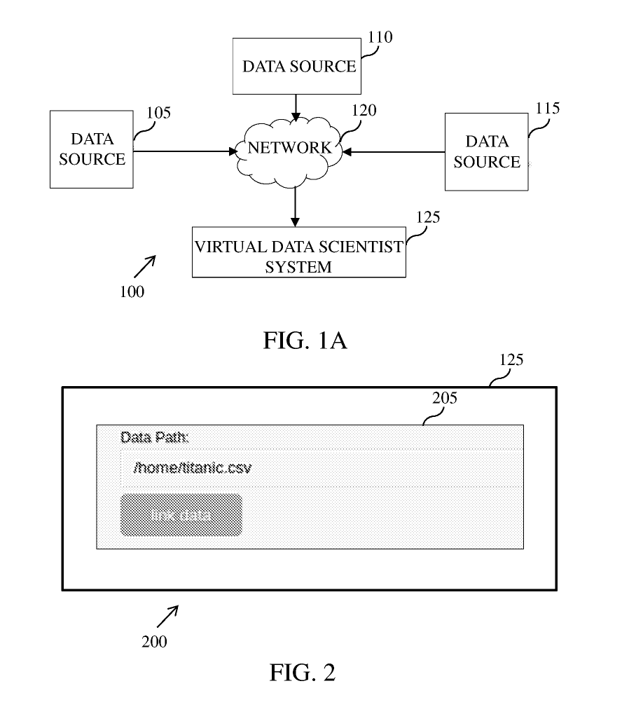

FIG. 1A is an example representation of an environment 100, in accordance with an embodiment. The environment 100 includes a data source 105, a data source 110, a data source 115, a network 120 and a virtual data agent system 125. Herein, the ‘virtual data agent system’ 125 refers to a system configured to provide data insights in order to make one or more decisions, to define business strategies, and the like, using artificial intelligence. In an example, the virtual data agent system 125 is a software package which combines data processing functionalities (for example, data filtering, data joining, data correlation, data union, data breaking, data aggregation, sampling, and the like), machine learning, data mining, prediction, forecast, recommendation and thought process of a data scientist using artificial intelligence. Examples of the data source 105, the data source 110, and the data source 115 include, but are not limited to, a cloud network, a data center, a local database, and the like. FIG. 1A is explained with respect to three data sources, for example the data source 105, the data source 110, and the data source 115. However, it should be noted that a plurality of data sources other than the depicted data sources can also be similarly included in the environment 100.

The virtual data agent system 125 communicates with the data source 105, the data source 110, and the data source 115 through the network 120. Examples of the virtual data agent system 125 include, but are not limited to, computers, mobile devices, tablets, laptops, palmtops, handheld devices, telecommunication devices, personal digital assistants (PDAs), servers, virtual environment, cloud infrastructure, and the like. Examples of the network 120 includes, but are not limited to, a Local Area Network (LAN), a Wireless Local Area Network (WLAN), a Wide Area Network (WAN), internet, a Small Area Network (SAN), a Storage Area Network (SAN), and the like.

The virtual data agent system 125 is configured to receive or access data from either a single data source or multiple data sources (for example, from the data sources 105-115). The data sources 105-115 can be located in any geographical area and is connected using a standard path, for example using the network 120, a local file sharing, and the like. The virtual data agent system 125 is further coupled to the data sources (105-115) using any standard protocol, for example FTP, SCP, and the like.

The data received from the data sources (105-115) can be of any format, for example csv, tsv, oracle database format, mysql data base format, image file formats, audio file formats, video file formats, binary file, text file, xml, json, and the like. The data from the data sources (105-115) can further be of any volume, for example in megabytes, gigabytes, petabytes, zetabytes, and the like.

The virtual data agent system 125 further processes the data using distributed processing supported by big data technologies, for example Hadoop, Spark, and the like.

The virtual data agent system 125 determines data insights from the data using artificial intelligence, rule based expert systems, neural networks, Bayesian Network, and the like.

In some embodiments, for audio data and video data formats, the virtual data agent system 125 can determine the data insights based on bit rate, data size, frequency spectrum, speech recognition, voice recognition, image and video recognition, MFCC, convolution neural networks, deep learning, and the like.

The virtual data agent system 125 further scores the data insights using one or more complex algorithms and logics. The virtual data agent system 125 prepares a list of the data insights based on the scores and only top scored data insights are made visible to a user (for example, business management) to act on the data insights.

The virtual data agent system 125 learns from user input like behaviour, choices and feedback on the data insights and stores such user specific inputs in the AI learning database 142 within the virtual data agent system 125. The virtual data agent system 125 hence behaves similar to a data scientist in observing and remembering the user needs. The virtual data agent system 125 further provides scoring of data insights and processing methods as per user needs and thus adapts itself as per the user needs.

In one example, the top elements (or combination of columns) of the list can be displayed using charts, graphs, 2D, 3D and other visual technologies including HTML/HTML5, web-server, CSS, Javascript, PHP, and the like, to the end user to effectively understand the data insights.

In some embodiments, the virtual data agent system 125 can use neural networks in the determination of the data insights. In other embodiments, the virtual data agent system 125 can use natural language processing (NLP) to interface with the user.

An example representation of the virtual data agent system 125 is explained in detail with reference to FIG. 1B.

FIG. 1B is an example representation of the virtual data agent system 125, in accordance with an embodiment. The virtual data agent system 125 includes a data fetching module 132, a data processing module 134, a sampling module 136, a data aggregation module 138, a data matrix 140, an AI learning database 142, a configuration database 144, a priority database 146, a domain expert 148, a data depth creation module 150, a scoring module 152, a machine learning and data mining module 154, a prediction, forecast and recommendation module 156, data insights 158, an intelligent QA module 160, a visualization module 162, a live trigger and alarms module 164, and other interfaces 166.

The data fetching module 132 links and fetches data from single or multiple data sources, for example a data source 168, a data source 170 to the data source 172.

The data processing module 134 processes raw data and produces structured data. The processes or techniques or tools that need to be applied to process the raw data is controlled and guided by Artificial Intelligence (AI). In some embodiments, further processing operations can be performed on the data including but not limited to data cleaning, data alignment, data auto fill, data correlation and joining. Input during the data processing can be obtained from and feedback provided to an AI learning database. To understand intelligence part in data processing and in other modules of the virtual data agent system 125, an example of joining two data sources to find expenses for a given month is taken into consideration. One row of data source1 is “<your name>, <your electricity bill>” for a given month and one row in data source2 is “<your name>, <your grocery bill>, <your grocery vendor name>” for the same month. Now to join both the data sources to find total expenses for that given month an intelligence is required to only add electricity bill (a numeric value) with the grocery bill (a numeric value) and not to add the name (a character string value) with the vendor name (a character string value) and not to add the electricity bill (a numeric value) with the grocery vendor name (a character string value). The intelligence is inbuilt in virtual data agent system 125 as Artificial Intelligence and manual intervention or human intelligence is not required to carry out tasks of data processing and the tasks of other modules of the present invention.

The data processing module 134 may include a step to identify the most significant population out of the full set of raw data records. In order to identify the most significant population, techniques like pareto principle (also known as the 80/20 rule) and outlier removal are applied. Statistical algorithms are used for outlier removals.

The pareto principle and outlier removal are applied to the target columns one by one and complete record/row is omitted when a column cell is selected for removal. A threshold is set such that the total number of records do not go below a level that is unsuitable for analysis.

Some example rule sets that are pre-defined in the AI learning database 142 are provided below to further explain the AI:

1. Data Type Analysis Rule Set:

Rule-1, If element is numeric then increment counter for NUMERIC_UNKNOWN and parse sub rules.

Sub Rule-1_1, If length is 12 digits & starts with 91, increment counter for NUMERIC_MSISDN_INDIA.

Sub Rule-1_2, If length is 10 digits, increment counter for NUMERIC_MSISDN_UNKNOWN.

Rule-2, If element is alphanumeric then increment counter for ALPHANUMERIC_UNKNOWN and parse sub rules.

Sub Rule-2_1, If length is 3-30, then increment counter for ALPHANUMERIC_NAME_UNKNOWN and parse sub rules.

Sub Rule-2_1_1, If data element can be find in AI learning database in a pre-defined table of human names, then increment counter for ALPHANUMERIC_NAME_HUMAN.

Sub Rule-2_2, If length is >200, then increment counter for ALPHANUMERIC_UNKNOWN_OVERFLOW.

Rule-3, Similar to above rules, If element is float, and precision and range are as per defined

configuration for LAT/LONG, increment counter for GPS_COORDINATES_LAT/LONG

respectively.

Upto Rule-n,default—increment counter for UNKNOWN.

The data processing module 134 processes all data elements of a column of data source and increases respective counters. The counters are then checked against threshold defined in the AI learning database 142. If the counters are greater than or equal to the defined threshold the column will be assigned that data type. For example, if the threshold defined is 90% for NUMERIC_MSISDN_INDIA in the AI learning database 142 and for a given column of a given data source the NUMERIC_MSISDN_INDIA counter is incremented 93 times out of 100 times (or 93% of data elements of that column), then that column will be assigned data type=NUMERIC_MSISDN_INDIA. Similarly, all columns of that data source will be analysed and assigned a data type. Data type assignment can be row-wise or the column-wise depending on data source.

If element doesn't match any of the rules then it will be assigned the data type defined by rule with maximum match followed by ‘unknown’—for example in Sub-Rule 2_1 it matches till name but the virtual data agent system 125 is unaware whether it is product name or animal name or something else so it will suffix ‘unknown’ to ALPHANUMERIC_NAME and result will be ALPHANUMERIC_NAME_UNKNOWN. The data type names (for example, NUMERIC_MSISDN_INDIA) are in alphanumeric format and are for illustration purpose. The data type names can be also defined in binary or integer format to best utilize available resources.

To understand the next rule set, two data sources are considered—DS1 and DS2 for example. DS1 is data from an e-commerce server and DS2 is call data record for SMS from a telecom operator.

DS1—<Date in mmddyyyy format>,<MobileNumberofPurchaser>,<ItemPurchased>

DS2—<Date in yyyymmdd format>,<MobileNumber>,<CallVolume>,<encrypted SMS Text>

When DS1 is passed through data analysis rule set (as discussed in previous paragraph), the

respective data types are identified as,

DataTypes[DS1]=Data Analysis Rule Set [DS1]=DATE_OTHER, NUMERIC_MSISDN_INDIA, ALPHANUMERIC_NAME_UNKNOWN_DS1

Similarly, DataTypes[DS2]=Data Anlysis Rule Set [DS2]=DATE_COMMON, NUMERIC_MSISDN_INDIA, NUMERIC_UNKNOWN_DS2,ALPHANUMERIC_UNKNOWN_OVERFLOW,

Now DS1 and DS2 are processed using data processing rule set as defined below.

2. Data Processing Rule Set:

Rule-1, if datatype=DATE_OTHER, then convert this data to DATE_COMMON format.

Rule-2, if datatype=NUMERIC_UNKNOWN_OVERFLOW, then filter out this data (meaning remove this data) from the data source.

Rule-3, if datatype=ALPHANUMERIC_UNKNOWN_OVERFLOW, then filter out this data from the data source.

Rule-4, if one or more data type of two or more data sources are same, then join these data sources.

Upto Rule-n.

In above example,

As per Rule-1, <Date in mmddyyyy format> in DS1 will be converted to DATE_COMMON (or yyyymmdd format which is configured in system to commonly use for all data sources) format so that system can use it later for matching dates.

Then, as per Rule-3, the <encrypted SMS text> will be filtered out from DS2.

Then, as per Rule-4, DS1 and DS2 will be joined to make a consolidated data.

The consolidated data will have fields=<Date in yyyymmdd format>,<MobileNumberofPurchaser as per DS1 or MobileNumber as per DS2>,<ItemPurchased>,<CallVolume>

and

The consolidated data will have data type=

DATE_COMMON,NUMERIC_MSISDN_INDIA,ALPHANUMERIC_NAME UN KNOWN, NUMERIC_UNKNOWN

The data processing module 134 keeps on updating the AI learning database 142 on each iteration or on processing of each column or on processing of each row. The data processing module 134 updates the AI learning database 142 with data size (of column or row), counters information, the selected thresholds and other related information. The thresholds can be learned (or modified) by input (or feedback) from other modules and also from the end user (using feedback through the visualization module 162 or through the iQA module 160 or e-mail interface, and the like) or the domain expertise 148 (through the configuration database 144). User questions may be answered by an IQA module The data processing module 134 also inserts the data elements in the AI learning database 142 as per a rule set. An example of this ruleset is given below:

3. AI Learning DB Insertion Rule Set:

Rule-1, If threshold criteria is met & datatype identified is ALPHANUMERIC_NAME_HUMAN then insert all the elements of this column (which are not found in AI learning database 142) in ALPHANUMERIC_NAME_HUMAN table in AI learning database 142. This way the AI learning database 142 will keep on adding new names or keep on memorizing additional human names on each iteration.

Rule-2, If threshold criteria is not met & datatype identified is ALPHANUMERIC_NAME_UNKNOWN then create a new table ALPHANUMERIC_NAME_UNKNOWN_<unique-identifier> and insert all the elements of this column or row in this table in the AI learning database 142. This table will get the data type identifier whenever any other module or the end user or the domain expert provide this information as feedback.

This way the AI learning database 142 not only adds new elements in existing tables but also adds new data types and will keep on learning with each iteration. There is also a master ruleset which guides and controls all the rulesets except itself as defined below:

4. AI Master Ruleset:

AI rules are also updated by the virtual data agent system 125 itself. This updating is controlled by the AI Master Ruleset.

Rule-1, If a new tables is added, add a new rule in Data Type Analysis Rule Set with a new data type.

The Master ruleset is finally controlled by human being using system configuration and the domain expertise 148.

The above description for Artificial Intelligence is explained with rule based expert system. The present invention also uses the neural networks, and any available algorithm/technology related to Artificial Intelligence. To process the raw data with high volumes the virtual data agent system 125 uses big data technology, for example Hadoop Cluster, Spark, SparkR and the related technology concepts for distributed processing.

The sampling module 136 performs sampling. The sampling plays a role in analysing data with higher volumes. For example, the data processing module 134 uses the sampling module 136 to parse the data sources through rulesets. The sampling module 136 starts parsing of data from a small number of elements and keep on increasing the number of data elements only if reaches the thresholds defined in the AI learning database 142. For example, to parse 1 million records through data type analysis rule set of data processing module 134, the virtual data agent system 125 will take initial sample of say 100 records. After parsing 100 records the virtual data agent system 125 will arrange the rules in decreasing order of counters values. The next sample will be of size derived from a mathematical equation (for instance, prevSampleSize×2, so in this case 200 samples). Now these samples will be parsed from rules in such a way that maximum probability of rule matching lies with rule with highest counter value during processing of previous samples. This way parsing of rules (or subrules) can be minimized and this will improve performance. A next sample size will again be derived from mathematical equation and this way sample size will keep on increasing until all elements of data source of a column (or row) are finished. In other examples, if number of samples processed till now exceeds a reverse threshold (that is, 100—threshold defined for that data type) then this rule can be rejected and need not pass remaining samples through this rule.

The data aggregation module 138 uses the Artificial Intelligence similar as described in the data processing module 134. The data aggregation module 138 summarizes transaction data and converts the transaction data into a squeezed form using statistical and similar algorithms like grouping, and the like. The aggregated data is stored in form of the data matrix 140. The data aggregation module 138 also uses Big Data technology for larger volumes. The data matrix 140 generates a squeezed form of all data sources processed and combined in a single view. In one of the embodiment, a clean unified view represents the most significant population of data that is used for analysis and models creation in subsequent steps.

The AI Learning Database 142 is a database for all leanings of the virtual data agent system 125. The AI Learning Database 142 is similar to a human memory which learns with experience and stores action points in memory. The first time the AI learning database 142 starts with thresholds and rulesets of the configuration database 144 and keeps on learning with experience. The configuration database 144 is a pre-defined database or a static database which gets updated only with human intervention. The configuration database 144 includes a master rule set and domain wise configuration to handle data.

The priority database 146 is a database to handle system priorities with respect to available resources. Based on user behavior, for example user selection of insights, user scoring of insights, user inputs and the like, the priority database 146 defines which datatype (or column or row) is given highest processing priority. Also, in case a user requested for a certain insight and that user is given highest priority (for example, user is CEO), then the processing of data sources with respect to such insight will get highest priority and all other processes not related to this insight will be put on hold until processing is finished.

The domain expert 148 is a module that acts as interface for inputs to be taken by the virtual data agent system 125 from various domain experts (for example, an operations team expert from telecom switching domain).

Domain Expert module captures the following information from a domain expert (a human being) and stores this information in its configuration and the AI learning database. The rewards (primary, secondary, tertiary and so on) in line with the business objectives of a given industry/business domain. For example, let's say the industry/business domain is online travel aggregator (OTA). The Business Objective is to increase the top-line. The primary reward for this objective is Increase of Revenues and one of the secondary rewards is the Increase in Quality of Hotel Listings present on the OTA platform. The domain expert module captures the mapping of column names in the data with respect to these rewards. e.g., increase of revenues (Primary Reward)->“Total Revenue” (column name), Quality of Hotel Listings (Secondary Reward)->“Website Content Score” (column name). The domain expert also captures the desired direction (increase, decrease, none) e.g., Increase in Revenue, Decrease in Cancellation Rates of Flights.

The causal directions for these rewards. This is effect-cause relationship between any two columns. Taking same OTA example, the Revenue is caused by Sales (number of hotel room nights sold). So the effect-cause direction is Sales->Revenue. Similarity, Room-Night Rate is also the cause for Revenue. The direction is, Room-Night Rate->Revenue. Similarly, Pageviews->Sales.

Causal Units, this is the unit information for each column, e.g., the unit of column “Sales” is room-night, and the unit of column Room-Night Rate is “USD per room-night”. The units aid AI algorithms to identify the right equation like Revenue (USD)=Sales (room-night)×Room-Night Rate (USD/room-night).

Causal Influence (or Weightage), this is the weight information captured by domain expert module with the help of domain expert (human). More the influence of an effect-cause relation, more is the weight. The weight is in scale of −1.0 to 1.0. For example, Sales->Revenue has a weight of 0.9 for a given industry, and Page-Views->Revenue has a weight of 0.7, and Page-Rank->Page-Views has a weight of −0.8, negative means lower the rank higher the Page-Views.

In one the embodiment, the domain expert inputs are based on Causal common currency i.e. a set of assumptions that are considered by the domain expert (human) while providing information to Domain Expert module. This ensures that the domain expert's (a human) thinking approach while providing information is in line with AI thinking approach. The first assumption is, all other variables (or columns) within the dataset are constant. e.g., Sale is the cause for Revenue assuming Room-Night Rate is constant, the answer is yes because more sale will lead to more revenue. The second assumption is, all other variables outside the dataset are favorable.

The data depth creation module 150 is the main module for finding insights with Artificial Intelligence. The data depth creation module 150 takes consolidated data as input from the data matrix 140 and generates opportunities (or insights) as output. The opportunities are sought at multiple data depths starting from Depth 0 till Depth n. Max number of depths are configurable and work reasonably well with n=4. The opportunity (also referred as “Opportunity Node”) of any depth is represented by a “Opportunity Measure” (one continuous column or a combination of more than one continuous columns), an “Opportunity Dimension” (zero categorical column for a Depth 0 opportunity or one categorical column for a Depth 1 opportunity or a combination of more than one categorical columns for a Depth n opportunity) and “Opportunity Magnitude”. The opportunities are found using one or more algorithms like cross tabulation, frequency, range, median, mathematical formulas, machine learning algorithms, neural network algorithms, Bayesian algorithms, evolutionary computing algorithms, rules. The opportunities are found with a target to maximize the opportunity magnitude. The system finds out opportunities in multiple ways including but not limited to following:

Deviation approach—this approach looks at the deviation from the expected value and if the absolute gap is above a threshold then considers the same as a potential opportunity and the absolute gap is the “Opportunity Magnitude”.

Expected Value—This can be a data-derived value like Average or a pre-defined value guided by a Domain Expert.

Threshold—Configurable threshold. A default value can be set at the beginning which can be updated by AI Learning Database. This threshold may also be defined by a Domain Expert and so will be received as an input from Domain Expert module.

### Example 1

Depth 1 Opportunity: Avg. Revenue (Opportunity Measure) of all the hotels having Rating (Opportunity Dimension) as 4.7 is $ X million less than the average revenue of all hotels across different ratings. Assumption: X is more than the set threshold.

### Example 2

Percentage Count (Opportunity Measure) of Females that Survived (Opportunity Dimension is combination of Gender and Survival Status) is X % more than the percentage of total passengers that Survived. Assumption: X is more than the set threshold.

Min Max approach—this approach finds out the minimum point and the maximum point. And, if the gap between these two points is above a threshold then it is considered a potential opportunity and the absolute gap between minimum and maximum value is the “Opportunity Magnitude”.

As an exemplary embodiment, example 1: Depth 1 Opportunity: Hotels with Rating 4.2 have the highest Avg. Revenue and hotels with Rating 4.7 is have the lowest Avg. Revenue.

Avg. Revenue (Opportunity Measure) of all the hotels having Rating (Opportunity Dimension) as 4.7 is $ X million less than the Avg. Revenue of all the hotels having Rating as 4.2. Assumption: X is more than the set threshold.

As another exemplary embodiment, example 2: Out of the passengers who survived i.e. (Survival Status=Survived), passengers with Gender=Male have the minimum percentage count and passengers with Gender=Female have the maximum percentage count. The percentage Count (Opportunity Measure) of Female passengers that Survived (Opportunity Dimension is combination of Gender and Survival Status) is X % more than the percentage Count of Male passengers that Survived. Assumption: X is more than the set threshold.

Outliers approach—this approach finds out the outliers in the dataset. One of the methods it uses to calculate the gap is the difference between outlier data points and the median of the data. If the gap is above a threshold then it is considered a potential opportunity and the absolute gap is the “Opportunity Magnitude”.

As an exemplary embodiment,

### Example

Depth 1 Opportunity: Hotels with Rating=0 have the average Revenue which is lies outside the normal distribution of Revenue of hotels across all ratings.

Depth 2 Opportunity: Passengers with PClass=3 and Surival Status=Survived have the percentage Count that lies outside the normal distribution of percentage count of Survived passengers across all PClass values.

Minority/Majority approach—this approach finds out the opportunities by categorizing the dataset in minority and majority and comparing the data points within these two categories.

Weird Points approach—this approach finds out the opportunity where in the point is weird or has much deviation from causal relations. E.g. a hotel with Rating 4.5 and Room-Night Rate at 5000/− has less average Sales than a hotel with Rating 4.2 and Room-Night Rate at 5500/−. Normally, a hotel with higher Rating and less Room-Night Rate has higher average Sales.

Intelligent Binning Approach—this approach finds out the opportunity by creating the bins of a opportunity measure and finds out a group of some of these bins as an opportunity. For example, Fare of Titanic Passengers, fare ranged from $0 to $500 is broken into X number of bins, and Y number of bins out of X are grouped. This group conveys opportunity that 93% of passengers had fare range of $4-$15, while total fare range is $0-$500.

Opportunity seeking process is recursive i.e. once an opportunity is found at a particular depth, the process goes on to find corresponding opportunities at other depths, generally higher ones. Example: In case of Male Survival Rate increase opportunity (Depth 1 Opportunity Node), the module goes on to next depth and looks at Passenger Class as well. The resultant opportunity is identified is that Males belonging to Passenger Class (Pclass) ‘3’ have lowest survival rate across all Males (Depth 2 Opportunity Node).

The Data Depth creation Module also updates these approaches to maximize the opportunity magnitude using one or more algorithms like cross tabulation, frequency, range, median, mathematical formulas, machine learning algorithms, neural network algorithms, Bayesian algorithms, evolutionary computing algorithms, rules. The above example of avg. revenue of hotels in deviation approach, takes the difference between two variables (say a and b). In one of the embodiment, the approach may be updated to take the difference between square of variables i.e. square of a—square of b so as to maximize the opportunity magnitude. In one of the embodiment, the approach may be updated to take the division between cube of variables i.e. cube of a—cube of b so as to maximize the opportunity magnitude. It may also update itself by taking information from AILDB on user feedbacks.

The Data Depth Creation module generates new “Opportunity Dimensions” and “Opportunity Measures” from the existing columns. The module passes any combination of existing “Opportunity Dimension” and “Opportunity Measure” columns i.e. existing categorical and continuous columns to generate new set of categorical and continuous columns which can be used as new “Opportunity Dimensions” and “Opportunity Measures”. Here is a generic representation of this process:

f(cat1, cat2, catn, cont1, cont2, contn)=cat′ or cont′. f represents a function which takes zero or more categorical columns and/or zero or more continuous columns, but at least one of the existing columns and returns a new categorical or continuous columns.

cat1, cat2, . . . , catn represent existing categorical columns

cont1, cont2, . . . , contn represent existing continuous columns

cat′ represents a new categorical column generated by function f

cont′ represents a new continuous column generated by function f

Some of the examples of new “Opportunity Dimensions” and “Opportunity Measures” generated by Data Depth Creation module:

Extract Titles From Names—Takes Categorical Column “Name”, strips title strings like Dr., Ms., Mr. etc. and returns a new Categorical Column as “Title” i.e. a new “Opportunity Dimension”

Create Profit from Cost Price and Profit Margin—Takes two continuous columns “Cost Price” and “Profit Margin”, multiplies them to generate a new continuous column “Profit” i.e. a new “Opportunity Measure”.

Create buckets of Room-Night Rate—takes one continuous column “Room-Night Rate”, creates multiple ranges or buckets and generates a new categorical column as “Room-Night Rate Range” i.e. a new “Opportunity Dimension” is generated from an existing “Opportunity Measure” column.

Create Rating Measure (numeric 1 to 5) from rating column—takes a categorical column “Rating” with values like Poor, Neutral, Good, Very Good, Excellent and convert it to a new column “Rating Measure” which has a linear representation ranging from 1 to 5.

Note that the Data Depth module first requests Sampling module to provide only a sample of rows before requesting Data Processing module to create new “Opportunity Dimension” or “Opportunity Measure” columns. Data Depth Creation module tests to seek opportunities (using above defined methods) within these sample rows for a particular newly created “Opportunity Dimension” or “Opportunity Measure” column. If any opportunity is found then Data Depth Creation module requests Data Processing Module to process the complete set of rows. It then starts the opportunity finding process on the complete set of rows.

The data depth creation module 150 uses the Artificial Intelligence similar as described in the data processing module 134. In addition to above mentioned AI, AI of the data depth creation module 150 also includes the depth architecture. The depth architecture generates insights starting from low depth or less complexity to high depth or more complexity. In each depth, the data matrix 140 is processed using one or more algorithms like cross tabulation, frequency, range, median, mathematical formulas, machine learning algorithms, neural networks algorithms, Bayesian algorithms, evolutionary computing algorithms, rules and the like. Such algorithms also include modifications to standard algorithms and formulas. Such data processing result (for example a table with two columns and two rows) is then passed to the scoring module 152. Based on the feedback from the scoring module 152 (in the form of score), above algorithms work on to find preferably insights which are most valuable for human beings to take decisions for business, environment or the betterment of human life.

The data depth creation module 150 of virtual data agent system 125 using artificial intelligence to determine the data insights operates in multiple depths architecture and is explained below. The multiple depths architecture is layered with increasing depths, for example a depth 0, a depth 1, and a depth 2. The following example is explained with respect to three depths. However, it should be noted that the depths can be extended to multiple levels and is not limited to three levels.

Depth 0 is defined as a level zero depth or an initial finding in which the depth creation module 150 of virtual data agent system 125 identifies, in one of the embodiment, count of unique members (or variables) of a column of the data and calculates percentage with respect to total members of respective column. The percentage is then compared with a threshold value defined in the AI learning database 142 for such environment. If the threshold value is not exceeded then the column is marked as a categorical variable. Such a process is repeated for all the columns of the data. It should be noted that other processes can be used for performing one or more of the above operations on the column, and is not limited to the above specified operations.

Depth 1 is defined as a level one depth where in the data depth creation module 150 of virtual data agent system 125 creates valuable information from the data at a first level. The data depth creation module 150 of virtual data agent system 125 prepares a list of combinations with two columns per combination of all columns which are marked as the categorical variable. For example if the columns marked as the categorical variable are A,B and C then list will inlcude AB, AC, and BC. The data depth creation module 150 of virtual data agent system 125 further prepares cross tabulation (or in a modified form) for each combination of the list. Each element of cross tabulation (or in a modified form) result is weighted and scored, as an example, with respect to deviation from normal. Such a process is repeated for each combination of the list. The list is further sorted in decreasing order of score in top of the list.

Depth 2 is defined as the level two depth where in the depth creation module 150 of virtual data agent system 125 creates the valuable information from the data at a second level. The virtual data agent system 125 prepares a list of combinations with three columns per combination of all columns which are marked as the categorical variable. For example, if the columns marked as the categorical variable are A, B, C and D then list will be ABC, ABD, ACD, BCD. The virtual data agent system 125 prepares the cross tabulation (or in a modified form) for each combination of the list. Each element of the cross tabulation (or in a modified form) result is weighted and scored, as an example, with respect to deviation from normal. Such a process is repeated for each combination of the list. The list is sorted in decreasing order of score with the valuable information in top elements of the list.

The depth creation module 150 of virtual data agent system 125 can further determine contextual data or find a new column from a column. The depth creation module 150 of virtual data agent system 125 uses time and resources to use and develop its intelligence. The depth creation module 150 of virtual data agent system 125 uses a list of delimiters configured previously and delimits a sample of data of a particular column to find out a unique percentage basis that corresponds to a delimiter. The depth creation module 150 of virtual data agent system 125 then compares the data with a defined threshold and if suitable the depth creation module 150 of virtual data agent system 125 starts penetrating a next sample of data with another larger sample and again performs comparison. Based on success or suitability, the depth creation module 150 of virtual data agent system 125 continues to deep dive the data and every time the data size increases by multi folding or adding or a given mathematical formula until the depth creation module 150 of virtual data agent system 125 has processed all of the members of that column. If the virtual data agent system 125 succeeds with the delimiter then the delimiter is given a higher score. During determination of the contextual data another time, the delimiter will be chosen from higher score to lower score, thereby increasing probability of finding the new column from existing column.

In some embodiments, when the depth creation module 150 of virtual data agent system 125 is finished with the list of delimiters, the depth creation module 150 of virtual data agent system 125 will work on finding the delimiters by itself by comparing the characters of the members of the columns. If some suitable delimiters are found, the depth creation module 150 of virtual data agent system 125 will add the same in a delimiter list of the AI learning database 142.

In some embodiments, once the user is shown a list of data values, the user will have an option to reject a comparison (least value for human being) or select a comparison (valuable for human being). The virtual data agent system 125 will remember such user selections and score the columns and the delimiters based on the user selections. The virtual data agent system 125 prioritize the processing from high scored elements to low scored elements.

The scoring module 152 uses the Artificial Intelligence similar as described in the data processing module 134. The scoring module 152 also has the ability to find out value or importance of a data insight. The scoring module 152 gives high scores to data insights which are more valuable for human beings. To understand how the scoring module 152 evaluates the data insight, in one example, if pattern is normal or it is a normal distribution then it will have the lower value while if there is a deviation from normal distribution then it will have the higher value. This is the same way human beings perceive usefulness of an insight. More is the deviation from normal, more is the usefulness. The scoring module 152 uses the statistical algorithms, mathematical formulas and related modifications to find out the value of the data insight. The scoring module 152 scores the data insights received from the data depth creation module 150 in such a way that is most useful for human being. The scoring module 152 takes as input all opportunity nodes produced by data depth creation module 150 and all ML Models generated by the machine learning (ML) and data mining module 154, and returns the most relevant Data Insights [158] as outcome.

Scoring Module follows the process as described below:
From list of Opportunity Nodes, pick each Opportunity Node one by one

For the Opportunity Node that's picked up for analysis:

Calculate Baseline Opportunity Score on the basis of Opportunity Magnitude. The baseline opportunity score is the usefulness for human beings in absence of guidance such as domain expertise module and user feedback. If Domain Expert module is present and so Rewards with respect to business objectives are pre-defined, then perform the following steps:

Starting from “Opportunity Measure”, identify best path leading to one of the Rewards. Path to a reward is identified using the cause-effect based ML Model for that reward. A path essentially comprises of contributing columns (causes) and their respective contribution co-efficient. Each path is then scored using a mathematical function ML Model and Causal Weight set by domain expertise module. Best path is the one that has highest score amongst multiple paths that may exist between “Opportunity Measure” and the rewards.

As an example:
Opportunity Node: Average number of Page-Views for hotels with Rating 4.7 is 58% less than the Average number of Page-Views for hotels with Rating 4.2

### Opportunity Measure: “Page-Views”

### Opportunity Depth=1 (One Categorical Column=“Rating”)

### Opportunity Dimension=“Rating”

Example Path for a Reward (for example “Total Revenue”)

### ML Model (Reward): Total Revenue=α×Sales+β×Room-Nights

### ML Model (Contributing Column): Sales=α1×Page-Views+β1×ConversionRate

### Path: Total Revenue<-Sales<-PageViews

Causal Relation1: Sales->Total Revenue with influence weight of 0.7,
Causal Relation2: PageViews->Sales with influence weight of 0.4

### Score=Mathematical Function (Causal Relation1, Causal Relation2, α, α1, β, β1)

The Mathematical function is an addition, but it can be optimized.
i. Identify the best path to reach the “Opportunity Measure” using ML Model for the “Opportunity Measure” and using gap analysis as explained below.

### Example

Opportunity Node: Average number of Page-Views for hotels with Rating 4.7 is 58% less than the Average number of Page-Views for hotels with Rating 4.2

### Opportunity Measure: “Page-Views”

### Opportunity Depth=1 (One Categorical Column=“Rating”)

### Opportunity Dimension=“Rating”

### Example ML Model for “Opportunity Measure”:

### Page-Views=α×Page Content Score+β×Number of Page Updates

### Path1: Page-Views<-Number of Page Updates

### Score for Path1=GapScorer (GAPF(“Opportunity Dimension”, “Opportunity Measure”),

### GAPF(“Opportunity Dimension”, “Page Updates”))

### Path2: Page-Views<-Page Content Score

### Score for Path2=GapScorer (GAPF(“Opportunity Dimension”, “Opportunity Measure”), GAPF(“Opportunity Dimension”, “Page Content Score”))

GAPF is a mathematical and statistical function.
GapScorer is a mathematical function.

### Best Path=Path1

Page Content Score is generally a more significant factor that contributes to Number of Pageviews (i.e. α>β). But when examined with reference to the given opportunity, it is found that there is no significant gap in the Page Content Score for Hotels with Rating 4.2 and the Page Content Score for hotels with Rating 4.7 and at the same time the Number of Page Updates for hotels with Rating 4.7 is much less than the Number of Page Updates for hotels with Rating 4.2. So in context of this opportunity, the root cause path for Pageviews will comprise of the Number of Page Updates node whereas Page Content Score node will be dropped from the root cause path.

Deduce the end to end path from Reward to root-cause in reference to the opportunity node that is under analysis. For example, the “Total Revenue” (reward of business objective)→Sales (Contributing Column) Pageviews→(“Opportunity Measure”)→Pageupdates (“Root Cause”)

Score the Opportunity. One of the methods that is used to score an opportunity is:

Take the Baseline Opportunity Score

If Domain Expert module is present and so are the rewards with respect to pre-defined objectives, then perform: identify the impact of Opportunity on amplitude of Business Objective in the desired direction of business objective.

Opportunity Score=Mathematical Function (baseline score, amplitude, score of end to end path from Reward to root-cause). A simple mathematical function is to multiply amplitude with path score and then add baseline score. This function can be optimized with experience and learnings.

Sort the Opportunities by Opportunity Score

Pick max. N (configurable) opportunities with highest Opportunity Scores as return those as Data Insights (158). N is generally a function of number of business objectives identified by the Domain Expert module [0048] and a threshold Opportunity Score.

Starting from “Opportunity Measure”, identify best path leading to one of the Rewards. Path to a reward is identified using the cause-effect based ML Model for that reward. A path essentially comprises of contributing columns (causes) and their respective contribution co-efficient

The scoring module also update itself by taking information from AILDB on user feedbacks. For example, if domain expetise module is not available, and scoring module generate baseline score of insights and user may feedback these insights based on usefulness. The scoring module will update itself based on these feedbacks. For example, scoring module scored an insight of Passenger Id (Serial Number) vs Fare to a maximum score but user may feedback as not important insight, the scoring module will reduce the weightage to a new value. The user feedback can be taken in multiple ways for example a simple button in visualization module or a simple scoring feedback mechanism in the visualization module.

The machine learning (ML) and data mining module 154 identifies the patterns and learns models using historical data (from the data matrix 140). The outcome is a model for each column present in the Data Matrix (138). Each model represents the cause and effect relationship by an equation between the target column (i.e. Effect) and contributing columns (i.e. causes). These Models are prepared using AI, Evolutionary Computing, ML and Data Mining algorithms for example Decision trees, Ensembles (Bagging, Boosting, Random forest), k-NN, Linear regression, Naive Bayes, Neural networks, Logistic regression, Perceptron, Relevance vector machine (RVM), Support vector machine (SVM), and the like. The ML and data mining module 154 creates the ML models using such algorithms and such models are used further for prediction and forecast along with data insights. Model creation process is primarily guided by—1. Causation Direction (provided by domain expertise module), 2. Causal units (provided by domain expertise module), 3. AI, ML and Evolutionary Computing algorithms, 4. Causal common currency, 5. Causal Influence/Weightage, 6. Causal Bucket Range or binning.

The prediction, forecast and recommendation module 156 uses ML Models and predicts and forecast (for example, time series) target basis input variables. The predictions and forecasts are linked with data insights to be viewed together for taking better decisions.

The data insights 158 are output of the present invention. The data insights are created in such a way that top scored data insights (that is insights with maximum usefulness for taking decisions) will be shown to end user. The virtual data agent system 125 keeps on learning with each iteration and keep on processing data to find more complex insights, so with passage of time (or resources usage for processing) the virtual data agent system 125 produces insights with better usefulness.

The intelligent QA module 160 generates questions and their answers both. Based on the plurality of questions, the questions may be analysed to find the data insights with maximum usefulness to end user or the human being. In addition, user can always ask question and system will provide the answers. User may also ask to predict or forecast questions.

The visualization module 162 enables the user to view the data insights in form of graphs, plots and the like, through a laptop web-browser or a mobile or any other electronic device. The user can share the feedback using the visualization module 162 by selecting a score (for example, 10 for most valuable insight, 1 for least, 0 for not required). User activities like tagging, moving an insight from one view to other, applying trigger on an insight, the AI may learn. Such feedback will be shared back to the AI learning database 142 so that thresholds and rulesets can be modified accordingly. Also, the user can edit the field names such as stack names, and the like. Such information will be passed to the AI learning database module 142.

The live trigger and alarms module 164 generates live alarms based on the data insights and prediction and forecast data. For example, if the virtual data agent system 125 is linked to the data source of historical earth-quake related parameters, and to data source sending live earth-quake related parameters for some locations, related alarms are generated. If based on the ML model, the virtual data agent system 125 predicts using live parameters that earth-quake probability for a certain location is more than defined threshold then the live trigger and alarms module 164 will send the alarm to concerned user or department. The virtual data agent system 125 can also be coupled to the other interfaces 166 for accessing the data insights. In one example, an end user can send an email to system email id and ask for certain insight. The virtual data agent system 125 can reply to the email using natural language processing and related technology with a plot snapshot in jpg or pdf format or any other format.

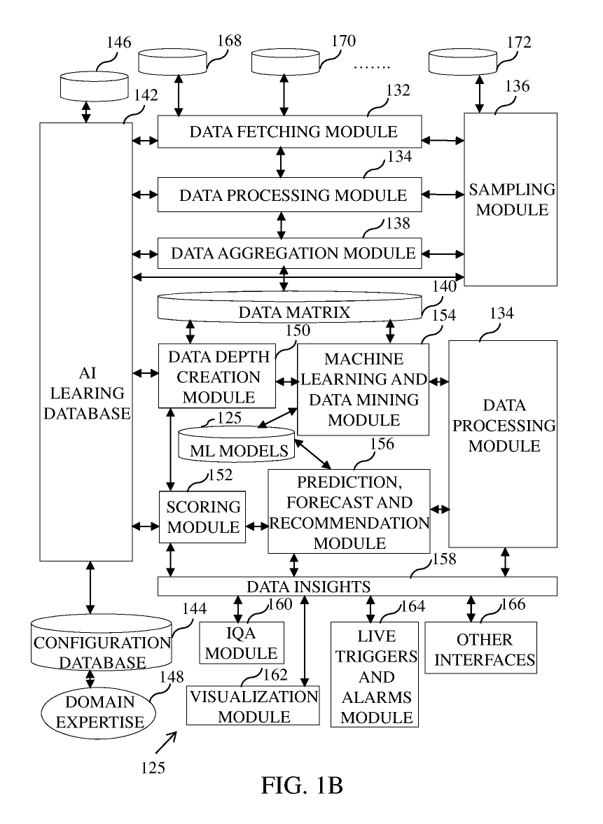

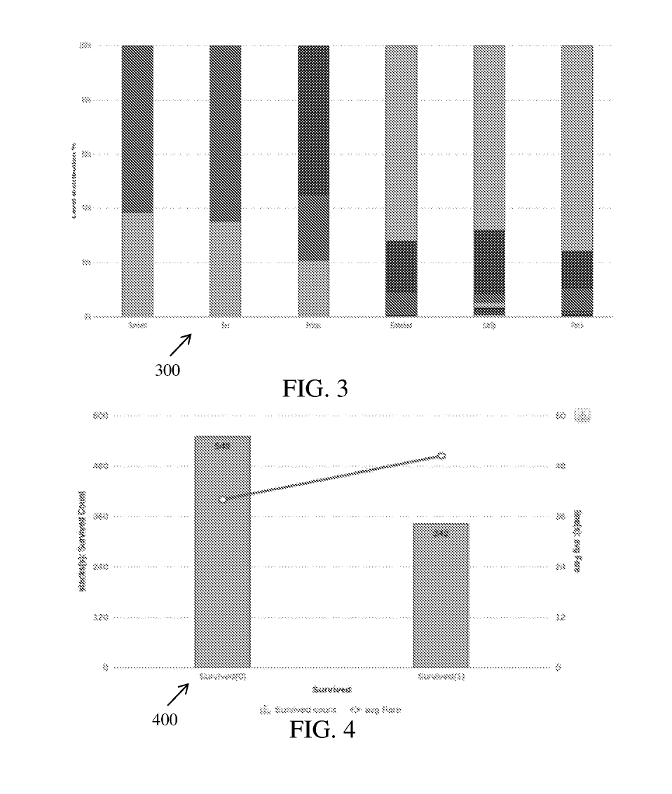

An example representation of operation of the virtual data agent system 125 is explained with reference to FIG. 2 and example representations of the data insights determined by the virtual data agent system 125 using one example is explained with reference to FIGS. 3 to 9.

FIG. 2 is a screenshot 200 illustrating a display screen of the virtual data agent system 125 during data linkage, in accordance with an embodiment. The user can provide a data path for the virtual data agent system 125 to access a data source, for example the data source 105, the data source 110 or the data source 115.

An example of Titanic mishap is used to explain the determination of the data insights using the virtual data agent system 125. In the Titanic mishap, RMS Titanic was a British passenger liner that sank in the North Atlantic Ocean in the early morning of 15 Apr. 1912 after colliding with an iceberg during a maiden voyage from Southampton, UK, to New York City, US.

In an example, the user can click an option for providing the data path and a pop-up window 205 may be displayed to the user on the display screen of the virtual data agent system 125. The screenshot 200 depicts the display screen of the virtual data agent system 125 and the pop-up window 205 includes a text entry box capable of receiving textual input corresponding to the data path. For the above example, the user can provide the data path “/home/titanic.csv” in the text entry box. The user can further click on an option ‘link data’ for linking the data from the data source associated with the data path.

The virtual data agent system 125 is linked to a csv file based on the data path provided. The virtual data agent system 125 further pulls the csv file, processes the data in the csv file and provides the data insights using the artificial intelligence and without any manual intervention.

In an example, the csv file includes data in a tabular format, as shown below in Table 1. A single row is illustrated in Table 1, however it should be noted that multiple rows can be present in the data, for example 891 rows in total. As illustrated in Table 1 below, the data includes 12 columns including passenger identification (ID) or sequence number of passenger, survived data (1 if survived or 0 if dead in mishap), passenger class (PClass) data, name, sex or gender, age, number of sibling or spouse (SibSp) on board, number of parent or children (ParCh) on board, ticket number, fare, cabin information, and port or ports embarked or boarded.

TABLE 1

| ID | Survived | PClass | Name | Sex | Age | SibSp | ParCh | Ticket | Fare | Cabin | Embarked |
|---|---|---|---|---|---|---|---|---|---|---|---|
| 1 | 0 | 3 | Braund, | Male | 22 | 1 | 0 | A/5 | 7.25 | | S |
| | | | Mr. | | | | | 21171 | | | |
| | | | Owen | | | | | | | | |
| | | | Harris | | | | | | | | |

In the Table 1 above, the data for one passenger is illustrated in the single row, for example with passenger ID ‘1’, survived ‘0’, PClass ‘3’, name ‘Mr. Owen Harris Braund’, sex ‘male’, age ‘22’, number of sibling or spouse (SibSp) on board ‘1’, number of parent or children (ParCh) on board ‘0’, ticket number ‘A/521171’, fare ‘7.25’, no cabin information, and port or ports embarked or boarded being ‘s’. Similarly, the data is present in other 890 rows correspondingly. Different graphical representations can be generated using the data from the data source and are explained with reference to FIGS. 3 to 9.

FIG. 3 is a graphical representation illustrating variation of level distribution with respect to input data, in accordance with an example embodiment. In FIG. 3, a plot 300 representing variation of the level distribution (plotted on Y-axis) against the input data (plotted on X-axis) using Depth 0 is shown. The plot 300 depicts survived data, sex data, PClass data, embarked data, SibSp data, ParCh, on the X-axis. The plot further depicts level distribution in percentage from 0% to 100% on the Y-axis.

The virtual data agent system 125 generates the plot 300 and in addition also raises important questions along with answers for the plot 300 related to the Depth 0 (less complexity). Some examples are as given below:

Q1—How many people survived? Ans—less than 40% people survived in mishap, rest died.
Q2—How many were male and how many were female? Ans—65% were male and 35% were female
Q3—What is class breakup? Ans—55% people belonged to Pclass3, 21% to Pclass2, 24% to Pclass1
Q4—How many people boarded from port S? Ans—72% peopled boarded from Embarked ‘S’
Q5—How many people travelled without a sibling or spouse? Ans—68% people travelled without sibling or spouse on board
Q6—How many people travelled without parent or child? Ans—76% people travelled without parent or child on board.

In an example, the virtual data agent system 125 raised the above questions pertaining to six columns only while there are twelve columns in the data (see, Table 1). This is because the virtual data agent system 125 determines that only the six columns have the valuable information for enabling the data insights and decisions to be taken by a human being.

FIG. 4 is a graphical representation illustrating variation of survived count with respect to average fare, in accordance with an embodiment. In FIG. 4, a plot 400 representing variation of the survived count (plotted on Y-axis) from 0 to 600 against the survived data (plotted on X-axis) using Depth 0 is shown. The plot 400 also represents average fare (plotted on Y′-axis) from 0 to 60 against the survived data (plotted on X-axis). The virtual data agent system 125 enables generation of the plot 400 and in addition also raises important questions along with answers for the plot 400 related to the Depth 0. For example, a question “was fare related to survival rate?” having an answer “The average fare of people who survived is higher than average fare of people who did not survive” can be provided by the virtual data agent system 125.

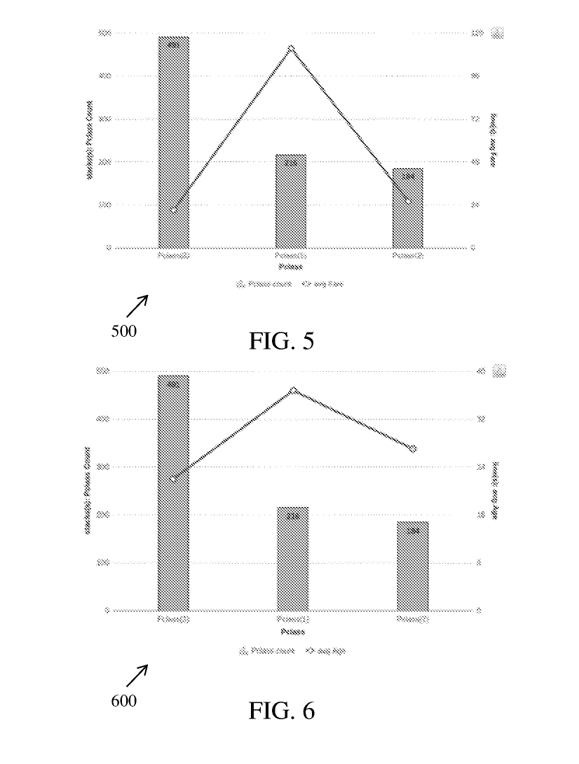

Referring now to FIG. 5, a graphical representation illustrating variation of passenger class (PClass) count with respect to average fare is provided, in accordance with an embodiment. In FIG. 5, a plot 500 representing variation of the PClass count (plotted on Y-axis) from 0 to 500 against the PClass data (plotted on X-axis) from PClass1 to PClass3 using Depth 0 is shown. The plot 500 also represents average fare (plotted on Y′-axis) from 0 to 120 against the PClass data (plotted on the X-axis). The virtual data agent system 125 generates the plot 500 and in addition also raises important questions along with answers for the plot 500 related to the Depth 0. For example, a question “What was average fare of Pclass1 as compared to other Pclass?” having an answer “The average fare of Pclass1 is higher than that of Pclass2, and the average fare of Pclass2 is higher than Pclass3” can be provided by the virtual data agent system 125.

Similarly, a plot 600 of FIG. 6 represents variation of the PClass count (plotted on Y-axis) from 0 to 500 against the PClass data (plotted on X-axis) from PClass1 to PClass3 and average age (plotted on Y′-axis) from 0 to 40 against the PClass data (plotted on the X-axis). The virtual data agent system 125 can raise a question, for example “What was average age of Pclass1 as compared to other Pclass?” having an answer “The average age of Pclass1 is higher than that of Pclass2, and the average age of Pclass2 is higher than Pclass3”. The above examples are only few top scored data insights that are fetched by the virtual data agent system 125 using artificial intelligence. The virtual data agent system 125 also identifies whether variable is categorical or continuous, for example age and fare are continuous variables and hence the virtual data agent system 125 has taken average of such variables.

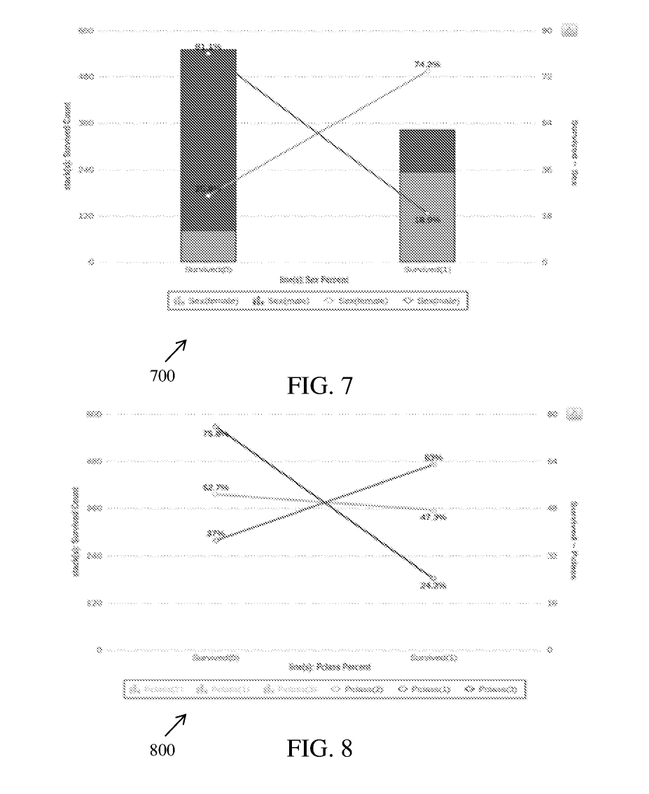

FIG. 7 is a graphical representation illustrating variation of survived count with respect to sex percentage of passengers, in accordance with an embodiment. In FIG. 7, a plot 700 representing variation of the survived count (plotted on Y-axis) from 0 to 600 against the sex percentage (plotted on X-axis) using Depth 1 is shown. The plot 700 also represents survived sex data (plotted on Y′-axis) from 0 to 90 against the sex percentage (plotted on X-axis). The virtual data agent system 125 generates the plot 700 and in addition also raises important questions along with answers for the plot 700 related to the Depth 1. For example, a question with a highest score of depth 1 is given below:

Q—What is survival rate of male and female respectively?
Ans—18.9% of male survived while 81.1% of female survived.

The above data insights enable decision makers to observe that a higher percentage of females survived in comparison to male survival rate and one possible reason can be that females were saved by men. Hence, management can use such information to plan a next voyage in such a way that men should also be saved, for example by providing more life jackets to men, and the like.

FIG. 8 is a graphical representation illustrating variation of survived count with respect to passenger class percentage, in accordance with an embodiment. In FIG. 8, a plot 800 representing variation of the survived count (plotted on Y-axis) from 0 to 600 against the survived PClass data (plotted on X-axis) using Depth 1 is shown. The plot 700 also represents PClass percentage (plotted on Y′-axis) from 0 to 80 against the survived PClass data (plotted on X-axis). The virtual data agent system 125 generates the plot 800 and in addition also raises important questions along with answers for the plot 800 related to the Depth 1. For example, a question with a second highest score of depth 1 is given below:

Q—What is survival rate of each Pclass?
Ans—63% of Pclass1 people survived while only 24% of Pclass3 survived.

The above data insights enable decision makers to observe that Pclass1 people knew swimming or may be Pclass1 people were given priority for life saving devices such as life jackets, boats, and the like. Hence, management can use such information to plan a next voyage in such a way that Pclass3 people can also be saved.

Similar to the Depth 0 and the Depth 1, the data insights for multiple levels including Depth 2 with increasing complexities of information can also be determined. For example:

Q—How many of females who didn't survive belonged to Pclass1?

### A—3.7%

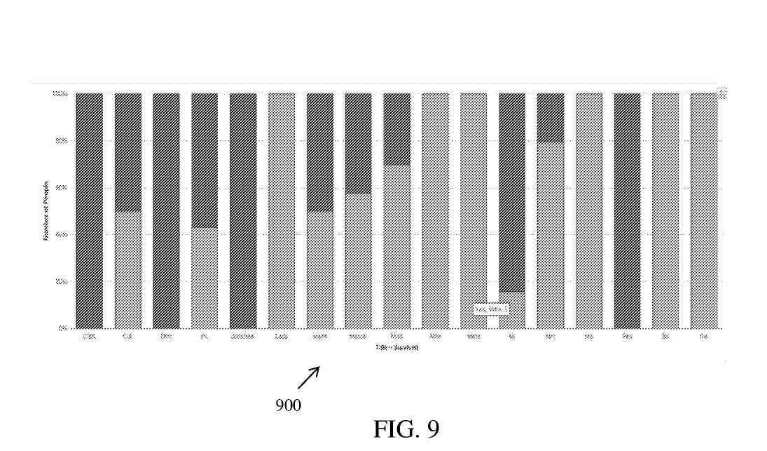

FIG. 9 is a graphical representation illustrating variation of number of people with respect to survival rate per title, in accordance with an embodiment. FIG. 9 is a graphical representation of the contextual data explained with reference to FIG. 1A and FIG. 1B using contextual level depth or intelligent depth. A plot 900 representing variation of the number of people (plotted on Y-axis) in percentage from 0% to 100% against the survival rate per title (plotted on X-axis) is shown. For example, some titles shown on the X-axis include Capt. for Captain, Col. for Colonel, Dr. for doctor, Lady, Miss, Mr, Mrs, Sir, and the like. For example, the virtual data agent system 125 determines the title in name of passenger and checks survival rate as per title. In the example of Mr. Owen Harris Braund, the virtual data agent system 125 detects the title ‘Mr.’ and determines that a spouse with the title ‘Mrs’ has survived. Similarly, other such survived data can be contextually gathered from each column.

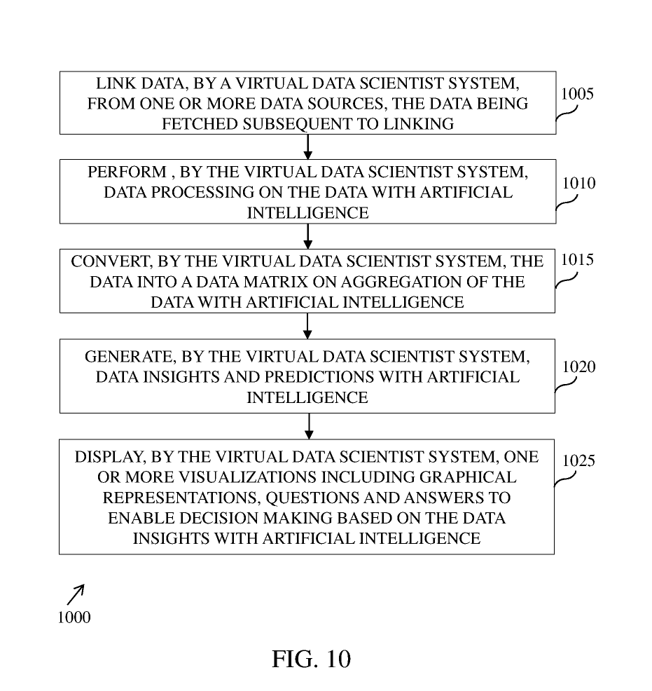

FIG. 10 illustrates an example flow diagram of a method 1000 for providing data insights based on artificial intelligence by a virtual data agent system, for example the virtual data agent system 125 in the environment 100 of FIG. 1A, in accordance with an embodiment. At step 1005, the method 1000 includes linking data from one or more data sources. The data sources, for example the data sources 105-115 of FIG. 1A, can be located in any geographical area and is connected using a standard path, for example using a network, a local file sharing, and the like. The data linked from the data sources is further fetched and can be of any format, for example csv, tsv, oracle database format, mysql data base format, image file formats, audio file formats, video file formats, binary file, text file, xml, json, and the like. The data from the data sources can further be of any volume, for example in megabytes, gigabytes, petabytes, zetabytes, and the like.

In some embodiments, the data can be fetched by the virtual data agent system or can be pushed by the data sources.

At step 1010, the method 1000 includes performing data processing on the data with artificial intelligence. In one example, the data is processed as samples that can be generated using a sampler. In some embodiments, further processing operations can be performed on the data including but not limited to data cleaning, data alignment, data auto fill, data correlation and joining. Input during the data processing can be obtained from and feedback provided to an AI learning database, for example the AI learning database 142 of FIG. 1B.

The data is further aggregated using data grouping and summarization. At step 1015, the method 1000 includes converting the data into a data matrix on aggregation of the data with the artificial intelligence. In some embodiments, variable types, for example continuous variables and categorical variables, are also separated. Input during the aggregation and conversion can be obtained from and feedback provided to the AI learning database, for example the AI learning database 142 of FIG. 1B.

In another example, the data insights that is generated by processing the data is scored using an insight scorer.

At step 1020, the method 1000 includes generating the data insights and predictions with artificial intelligence. Input during generation of the data insights can be obtained from and feedback provided to the AI learning database, for example the AI learning database 142 of FIG. 1B.

At step 1025, the method 1000 includes displaying one or more visualizations including graphical representations, questions and answers to enable decision making based on the data insights with the artificial intelligence. The one or more visualizations can be displayed on a display screen of an end user device, for example a mobile phone, a tablet, and the like. Some example representations of the determination of the one or more visualizations and data insights are explained with reference to FIGS. 3-9 and are not explained herein for sake of brevity. Input during the display can be obtained from and feedback provided to the AI learning database, for example the AI learning database 142 of FIG. 1B.

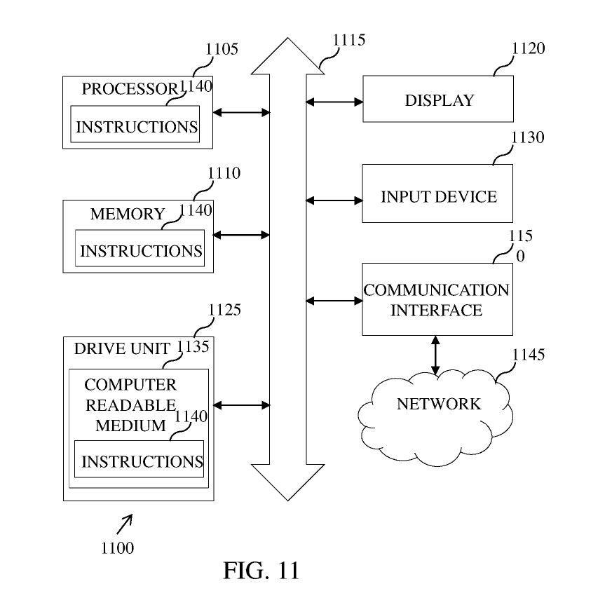

Referring to FIG. 11, illustrates a block diagram of an electronic device 1100, which is representative of a hardware environment for practicing the present invention. The electronic device 1100 can include a set of instructions that can be executed to cause the electronic device 1100 to perform any one or more of the methods disclosed. The electronic device 1100 may operate as a standalone device or can be connected, for example using a network, to other electronic devices or peripheral devices.

In a networked deployment of the present invention, the electronic device 1100 may operate in the capacity of a data source, for example the data source 105, the data source 110, or the data source 115 of FIG. 1A, a virtual data agent system, for example the virtual data agent system 125 of FIG. 1A, in a server-client user network environment, or as a peer electronic device in a peer-to-peer (or distributed) network environment. The electronic device 1100 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In some examples, the electronic device can be implemented as a server, for example IBM P Series or X Series, or be deployed over Virtual Machine Environments, for example VMware, or be deployed over cloud infrastructure. Further, while a single electronic device 1100 is illustrated, the term “device” shall also be taken to include any collection of systems or sub-systems that individually or jointly execute a set, or multiple sets, of instructions to perform one or more computer functions.

The electronic device 1100 can include a processor 1105, for example a central processing unit (CPU), a graphics processing unit (GPU), or both. The processor 1105 can be a component in a variety of systems. For example, the processor 1105 can be part of a standard personal computer or a workstation. The processor 1105 can be one or more general processors, digital signal processors, application specific integrated circuits, field programmable gate arrays, servers, networks, digital circuits, analog circuits, combinations thereof, or other now known or later developed devices for analyzing and processing data. The processor 1105 can implement a software program, such as code generated manually (for example, programmed).

The electronic device 1100 can include a memory 1110, such as a memory 1110 that can communicate via a bus 1115. The memory 1110 can include a main memory, a static memory, or a dynamic memory. The memory 1110 can include, but is not limited to, computer readable storage media such as various types of volatile and non-volatile storage media, including but not limited to, random access memory, read-only memory, programmable read-only memory, electrically programmable read-only memory, electrically erasable read-only memory, flash memory, magnetic tape or disk, optical media and the like. In one example, the memory 1110 includes a cache or random access memory for the processor 1105. In alternative examples, the memory 1110 is separate from the processor 1105, such as a cache memory of a processor, the system memory, or other memory. The memory 1110 can be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1110 is operable to store instructions executable by the processor 1105. The functions, acts or tasks illustrated in the figures or described can be performed by the programmed processor 1105 executing the instructions stored in the memory 1110. The functions, acts or tasks are independent of the particular type of instructions set, storage media, processor or processing strategy and can be performed by software, hardware, integrated circuits, firm-ware, micro-code and the like, operating alone or in combination. Likewise, processing strategies can include multiprocessing, multitasking, parallel processing and the like.

As shown, the electronic device 1100 can further include a display unit 1120, for example a liquid crystal display (LCD), an organic light emitting diode (OLED), a flat panel display, a solid state display, a cathode ray tube (CRT), a projector, a printer or other now known or later developed display device for outputting determined information. The display 1120 can act as an interface for a user to see the functioning of the processor 1105, or specifically as an interface with the software stored in the memory 1110 or in a drive unit 1125.

Additionally, the electronic device 1100 can include an input device 1130 configured to allow the user to interact with any of the components of the electronic device 1100. The input device 1130 can include a stylus, a number pad, a keyboard, or a cursor control device, for example a mouse, or a joystick, touch screen display, remote control or any other device operative to interact with the electronic device 1100.

The electronic device 1100 can also include the drive unit 1125. The drive unit 1125 can include a computer-readable medium 1135 in which one or more sets of instructions 1140, for example software, can be embedded. Further, the instructions 1140 can embody one or more of the methods or logic as described. In a particular example, the instructions 1140 can reside completely, or at least partially, within the memory 1110 or within the processor 1105 during execution by the electronic device 1100. The memory 1110 and the processor 1105 can also include computer-readable media as discussed above.

The present invention contemplates a computer-readable medium that includes instructions 1140 or receives and executes the instructions 1140 responsive to a propagated signal so that a device connected to a network 1145 can communicate voice, video, audio, images or any other data over the network 1145. Further, the instructions 1145 can be transmitted or received over the network 1145 via a communication port or communication interface 1150 or using the bus 1115. The communication interface 1150 can be a part of the processor 1105 or can be a separate component. The communication interface 1150 can be created in software or can be a physical connection in hardware. The communication interface 1150 can be configured to connect with the network 1145, external media, the display 1120, or any other components in the electronic device 1100 or combinations thereof. The connection with the network 1145 can be a physical connection, such as a wired Ethernet connection or can be established wirelessly as discussed later. Likewise, the additional connections with other components of the electronic device 1100 can be physical connections or can be established wirelessly. The network 1145 can alternatively be directly connected to the bus 1115.

The network 1145 can include wired networks, wireless networks, Ethernet AVB networks, or combinations thereof. The wireless network can include a cellular telephone network, an 802.11, 802.16, 802.20, 802.1Q or WiMAX network. Further, the network 1145 can be a public network, such as the Internet, a private network, such as an intranet, or combinations thereof, and can utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the electronic device 1100.

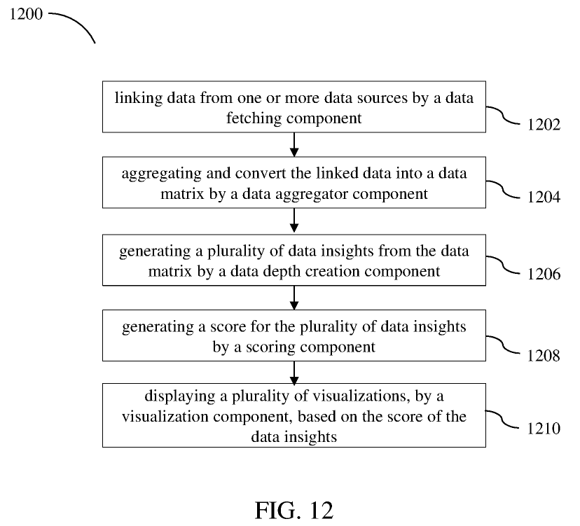

Referring to FIG. 12, illustrates a process flow diagram of a method 1200 to generate a plurality of insights using a virtual data engine. At step 1202, data may be linked from one or more data sources by a data fetching component. At step 1204, the linked data may be aggregated and converted into a data matrix by a data aggregator component. At step 1206, a plurality of data insights may be generated from the data matrix by a data depth creation component. At step 1208, a score may be generated for the plurality of data insights by a scoring component. At step 1210, a plurality of visualizations may be displayed, by a visualization component, based on the score of the data insights

One or more examples described can implement functions using two or more specific interconnected hardware modules or devices with related control and data signals that can be communicated between and through modules, or as portions of an application-specific integrated circuit. Accordingly, the present system encompasses software, firmware, and hardware implementations.

The system described can be implemented by software programs executable by an electronic device. Further, in a non-limited example, implementations can include distributed processing, component/object distributed processing, and parallel processing. Alternatively, virtual electronic device processing can be constructed to implement various parts of the system.

The system is not limited to operation with any particular standards and protocols. For example, standards for Internet and other packet switched network transmission (for example, TCP/IP, UDP/IP, HTML, HTTP) can be used. Such standards are periodically superseded by faster or more efficient equivalents having essentially the same functions. Accordingly, replacement standards and protocols having the same or similar functions as those disclosed are considered equivalents thereof.

Various embodiments disclosed herein provide numerous advantages by providing a method and system for providing data insights based on artificial intelligence. The present invention uses a virtual data agent system to determine data insights, both simple and complex, based on artificial intelligence. The present invention is a mixture of both analytics tool and data scientist in order to provide data insights to an end user based on leanings of previous data processing. The present invention is operational at all times of day and further provides the data insights in question—answer format making it easier for The present invention allows reduction in time spent by managements during decision making, and to procure data at a right time.

While specific language has been used to describe the disclosure, any limitations arising on account of the same are not intended. As would be apparent to a person in the art, various working modifications may be made to the method in order to implement the inventive concept as taught herein.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1. A virtual data agent comprising:
a processor;
a memory communicatively coupled to the processor, configured for:
linking data from one or more data sources by a data fetching component,
aggregating and convert the linked data into a data matrix by a data aggregator component,
generating a plurality of data insights from the data matrix by a data depth creation component,
generating a score for the plurality of data insights by a scoring component, and
displaying a plurality of visualizations, by a visualization component, based on the score of the data insights,
processing big data using a sampling component, and
improving intelligence by an AI learning database component.

2. The system of claim 1, wherein the data depth creation component of the virtual data agent includes a depth architecture to generate the plurality of data insights starting from low depth to high depth.

3. The system of claim 1, wherein the data depth creation component of the virtual data agent generates a plurality of opportunities at multiple data depths.

4. The system of claim 3, wherein the opportunities are found in multiple ways using a deviation approach, min max approach, outliers approach, minority/majority approach, intelligent binning approach and the like.

5. The system of claim 1, wherein the data depth creation component of the virtual data agent generates opportunities using a recursive process.

6. The system of claim 1, wherein the data depth creation component of the virtual data agent updates the approaches to find out the opportunities.

7. The system of claim 1, wherein the data depth creation component of the virtual data agent generates Opportunity Dimensions and Opportunity Measures to find more opportunities.

8. The system of claim 1, wherein the data depth creation component of the virtual data agent includes use of one or more algorithms like cross tabulation, frequency, range, median, mathematical formulas, machine learning algorithms, neural network algorithms, Bayesian algorithms, evolutionary computing algorithms, rules and rules based expert systems.

9. The system of claim 1, wherein the data depth creation component of the virtual data agent uses sampling component for analysing data with higher volumes.

10. The system of claim 1, wherein the sampling component analyses data with higher volumes.

11. The system of claim 1, wherein the scoring component scores the plurality of data insights received from the data depth creation component based on the usefulness of the plurality of data insights.

12. The system of claim 1, wherein the scoring component of the virtual data agent updates the scoring mechanism.

13. The system of claim 11, wherein the system deduces the best end to end path from root cause to the reward.

14. The system of claim 1, wherein the data visualization component enables one or more users to view the plurality of data insights in the form of graphs, plots and the like.

15. A method of generating a plurality of data insights, the method comprising the steps of:
linking data from one or more data sources
aggregating and converting the linked data into a data matrix;
generating a plurality of data insights from the data matrix;
generating a score for the plurality of data insights; and
displaying a plurality of visualizations based on the score of the plurality of data insights

16. The method of claim 15, wherein the method comprises generating the data matrix.

17. The method of claim 15, wherein the method comprises generating the plurality of data insights starting from low depth to high depth.

18. The method of claim 15, wherein the method comprises processing the data matrix in each depth using one or more algorithms like cross tabulation, frequency, range, median, mathematical formulas, machine learning algorithms, neural networks algorithms, Bayesian algorithms, evolutionary computing algorithms, rules and rules based expert systems.

19. The method of claim 15, wherein a plurality of opportunities are sought at multiple data depths, and the opportunities are found in multiple ways using a deviation approach, min max approach, outliers approach, minority/majority approach, intelligent binning approach and the like.

20. The method of claim 19, wherein seeking opportunities is a recursive process.

21. The method of claim 15, wherein Opportunity Dimensions and Opportunity Measures are generated to find more opportunities.

22. The method of claim 15, wherein the method comprises scoring the plurality of data insights based on the usefulness of the plurality of data insights.

23. The method of claim 22, wherein the method deduces the best end to end path from root cause to the reward.

24. The method of claim 15, wherein the method comprises viewing the plurality of data insights in the form of graphs, plots and the like.

25. The method of claim 15, wherein the method comprises updating the approaches to find out the opportunities by the data depth creation component of the virtual data agent.

26. The method of claim 15, wherein the method comprises updating the scoring mechanism by the scoring component of the virtual data agent.
